(19) United States
(12) Patent Application Publication
(10) Pub. No.: US 2012/0013091 A1
(43) Pub. Date: Jan. 19, 2012

(54) Insulated Utility Wagon

(76) Inventor: Ryan Ross Giese, Dayton, TX (US)

(21) Appl. No.: 12/834,978

(22) Filed: Jul. 13, 2010

(51) Int. Cl. B62B 3/00

(52) U.S. Cl. 280/47.35

(57) ABSTRACT

An apparatus has a body having an interior space formed therein, a lid hingedly attached adjacent the top of the body, walls extending upwardly from a periphery of the top of the body, wheels attached to a bottom of the body, and a handle pivotally attached to a front of the body. The body thermally insulates the interior space, and the lid thermally insulates the interior space when in a closed position. A portion of the interior space has a trapezoidal shape. The body has angled portions that dampen a movement of items in the interior space. The lid and body have layers, where the outermost layers provide structure and support, and the inner layers provide insulation and dampening for items in the interior space.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The disclosed invention relates to toy wagons. Additionally, the disclosed invention relates to insulated apparatus, such as ice chests, coolers, and food carriers. More particularly, the disclosed invention relates to toy wagons having the dual utility of transporting and insulating items.

2. Description of Related Art

Toy wagons are well known in the United States, and many children have played with toy wagons since such wagons were introduced in the U.S. in the late 1800's. The design of toy wagons has remained fairly constant over time—a standard toy wagon generally consists of a body having a horizontally disposed surface and upstanding front, rear and side walls formed around the periphery of this surface. Four wheels are attached to the bottom of the horizontal surface and a handle is typically attached to either the front of the wagon body or to a pivoting bolster to which the front wheels of the wagon are attached. Toy wagons are typically made from wood, plastic, metal, or a combination thereof.

A problem associated with toy wagons is their primary use: toy wagons are typically used for play by children. Toy wagons while durable for use by children are manufactured for this particular use. Such manufacture prevents effective use of toy wagons for more utilitarian purposes, such as transporting items. For example, typical toy wagons have walls of a limited height so that children can get on and off the wagon easily to play. However, the limited height of the walls makes the wagons unsuitable for transporting items from one's car to the beach. In this case, it is common to load the wagon with beach items. The items easily fall over the walls as the toy wagon is pulled over the sand, and items also fall over the walls during transport over other uneven terrains. Thus, there is a need for a wagon similar in size to a toy wagon that allows people to easily transport items to the beach, to a picnic, etc., without having the items easily fall over the walls of the wagon.

Insulating devices such as coolers and ice chests are common, and coolers and ice chests can be manufactured with wheels. A problem associated with prior art wheeled-insulating devices is the wheels are unsuitable for transport over uneven terrain, such as sand at the beach. Moreover, these insulating devices are inadequate for transporting items externally of the device, as items have to be secured to the device with securing mechanisms such as bungee cords. Thus, there is a need for an insulating device that better travels over uneven terrain and better accommodates for the transport of items externally located of the insulating device.

Another problem associated with the prior art is lack of ability to keep beverages cold in a cooler while transporting other items such as a blanket, non-perishables, clothes, and tableware, the person must transport the beverages separately from the blanket, tableware, clothes, and non-perishables due to the shortcomings discussed above. Thus, there is a need for an apparatus that allows for transport of both beverages that need insulation to stay cold or warm and other items which do not need insulation so as to simplify recreational experiences, such as picnicking and going to the beach.

### SUMMARY OF THE INVENTION

The disclosed invention is an apparatus comprising a body, a lid hingedly attached to the the top of the body, walls extending upwardly from the top of the body, wheels attached to a bottom of the body, and a handle pivotally attached to a front of the body. Each of the walls is adjacent a periphery of the body. The walls define an enclosed space above the body, and the lid is accessible through the enclosed space defined by the walls. At least two of the wheels are rotatable with respect to the body.

The body has an interior space, and the body thermally insulates this interior space. At least a portion of the interior space of the body has a trapezoidal profile. The lid has an open position and a closed position, and the lid thermally insulates the interior space when in the closed position. The lid is planar with a top of the body when in the closed position. The lid is in interference-fit relationship with the top of the body when the lid is in the closed position.

The walls comprise a first wall having a side and an opposite side, a second wall having a side in contact with the opposite side of the first wall, a third wall having a side in contact with an opposite side of the second wall, and a fourth wall having a side in contact with an opposite side of the third wall. The fourth wall also has an opposite side in contact with the side of the first wall.

The body comprises a first portion, a second portion angled with respect to the first portion, and a third portion angled with respect to the second portion. The second portion is positioned between the first portion and the third portion. The angle between the first portion and the second portion is obtuse, and the angle between the second portion and the third portion is obtuse. The angled configuration of the first, second, and third portions of the body dampens movement of items in the interior space using counter-acting forces of gravity and friction.

The lid and body have layers that serve to support the apparatus, insulate items in the interior space, and dampen the movement of items in the interior space. The layers are made of polymeric materials and can have different densities. The innermost layer preferably has some degree of elasticity so as to dampen a movement of items in the interior space. The layers are configured so that the outermost layer primarily provides support and structure for the inner layers, and the inner layer(s) primarily provide insulation and dampening of items in the interior space of the apparatus. The layers are generally impermeable to H₂O.

It is an object to provide an insulated utility wagon that insulates and transports food and drinks while storing and transporting other items.

It is another object to provide an insulated utility wagon that dampens forces originating externally therefrom so as to minimize disturbance of the contents thereof.

It is another object to provide an insulated utility wagon that counteracts external forces using gravity and friction.

It is another object to provide an insulated utility wagon that that can thermally insulate both cold and hot items.

It is another object to provide an insulated utility wagon that is rigid, yet light in weight.

It is another object to provide an insulated utility wagon that easily moves over different terrains.

It is another object to provide an insulated utility wagon that resists corrosion.

The objects and advantages of the invention are not limited to those disclosed above. These objects and advantages are made apparent by the specification and claims.

### BRIEF DESCRIPTION OF THE SEVERAL VIEWS OF THE DRAWINGS

FIG. 1 shows a perspective view of the preferred embodiment of the disclosed apparatus.

FIG. 2 shows a cross-sectional view of the disclosed apparatus, taken along sight line 2-2 in FIG. 1.

FIG. 3 shows a cross-sectional view of the disclosed apparatus, with a horizontal external force exerted on the back of the apparatus.

FIG. 4 shows a cross-sectional view of the disclosed apparatus, with a horizontal external force exerted on the front of the apparatus.

FIG. 5 shows a cross-sectional view of the disclosed apparatus showing two layers of the body and lid.

FIG. 6 shows a cross-sectional view of the disclosed apparatus showing three layers of the body and lid.

### DETAILED DESCRIPTION OF THE PREFERRED EMBODIMENT(S)

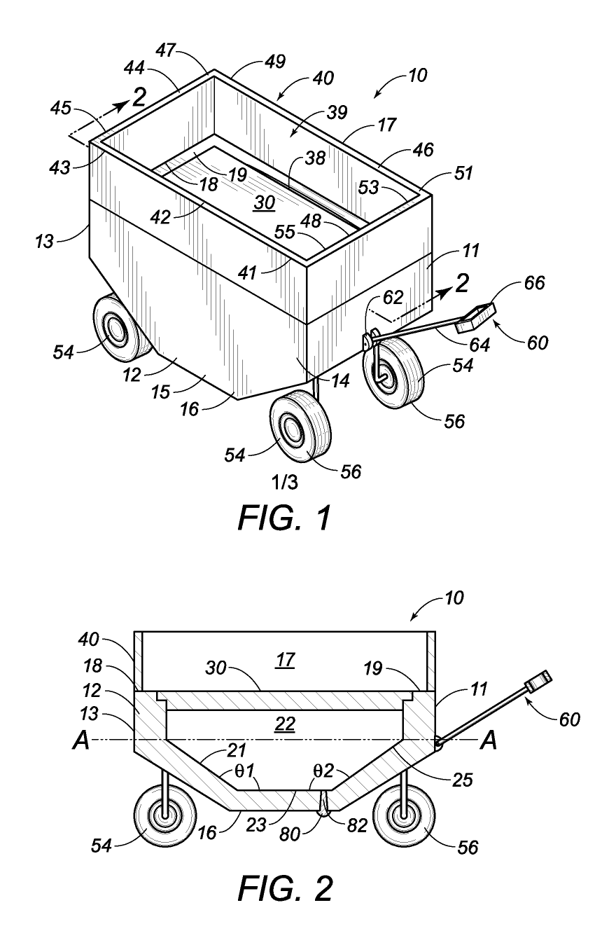

Referring to FIG. 1, there is shown a perspective view of the preferred embodiment of the disclosed apparatus 10. The apparatus 10 has a body 12. The body 12 has a top 14, bottom 16, front 11, back 13, side 15, and side 17. Wheels 54 are attached to the bottom 16 of the body 12 of the apparatus 10. Two 56 of the wheels 54 adjacent the front 11 of the body 12 are rotatable with respect to the body 12. A handle 60 is pivotally attached to the front 11 of the body 12. The handle 60 has a pivot joint 62 attached to the front 11 of the body 12, a shaft 64 pivotally attached to the pivot joint 62, and a grip 66 attached to an end of the shaft 64 opposite the pivot joint 62. The wheels 54 are large to easily travel over uneven terrain such as sand, and two 56 of wheels 54 crucially pivot to guide the apparatus 10 around obstacles in uneven terrain.

The apparatus 10 has walls 40 that extend upwardly from the top 14 of the body 12. The walls 40 have a first wall 42, a second wall 44, a third wall 46, and a fourth wall 48. The first wall 42 has a side 41 and an opposite side 43. A side 45 of the second wall 44 contacts the opposite side 43 of the first wall 42. A side 49 of the third wall 46 contacts an opposite side 47 of the second wall 44. A side 53 of the fourth wall 48 contacts an opposite side 51 of the third wall 46, and an opposite side 55 of the fourth wall 48 contacts the side 41 of the first wall 42. The walls 40 can be integrally formed with the body 12 of the apparatus 10, and the walls 40 can be made of a high-density polymeric material.

The walls 40 define an enclosed space 39 above the body 12. Each of the walls 40 is adjacent the periphery 18 of the top 14 of the body 12. The walls 40 extend vertically upwardly from the periphery 18 of the top of the body 12 and preferably have a height of six inches or more. The walls 40 have a height that allows people to easily transport items to the beach, to a picnic, etc., without having the items easily fall over the walls of the wagon. The walls 40 accommodate for the transport of items externally located of the body 12.

A lid 30 is attached adjacent the top 14 of the body 12 by a hinge 38. The lid 30 has an open position and a closed position, and the lid 30 is shown in the closed position in FIG. 1. The lid 30 is accessible through the enclosed space 39 defined by the walls 40. As can be seen in FIG. 1, the lid 30 is planar with the top 14 of the body 12 when in the closed position. The top 14 of the body 12 has a lip 19 that extends inwardly from the periphery 18 of the top 14 of the body 12 further than the walls 40. The lid 30 and the lip 19 are in interference-fit relationship when the lid 30 is in the closed position. The hinge 38 is attached to the lip 19 and to the lid 30. The lid 30 is shown in FIG. 1 as hingedly attached to the lip 19 adjacent side 17 of the apparatus 10; however, the lid 30 can be hingedly attached to the side 15, front 11, or back 13 of the body 12. Moreover, the disclosed invention contemplates multiple lids attached to the lip 19 for a more selective access to contents placed in the interior space 22 of the body 12.

Referring to FIG. 2, there is shown a cross-sectional view of the apparatus 10, taken along sight-line 2-2 drawn in FIG. 1. At least a portion of the interior space 22 has a trapezoidal profile, which reduces forces imparted to items contained in the interior space 22 when the apparatus 10 is suddenly stopped from being in motion, or is suddenly started from being stationary. In FIG. 2, the trapezoidal portion of the interior space 22 is below dashed-dotted line A-A. Thus, the apparatus 10 has an interior space 22 with a portion that has a trapezoidal profile below line A-A and a rectangular profile above line A-A. However, the disclosed invention contemplates the interior space 22 can have an entirely trapezoidal profile. That is, the lid 30 and the body 12 can form a trapezoidal profile when the lid 30 is in the closed position.

A drain plug 80 is inserted into a drain hole 82 formed in the second portion 23 of the bottom 16 of the body 12. When ice is used to cool contents of the apparatus 10, the ice is placed in the interior space 22. Naturally over time, the ice melts, leaving liquid H₂O in the bottom 16 of the body 12. The drain plug 80 can be removed from the drain hole 82 to allow for removal of liquid H₂O from the interior space 22 of the apparatus 10. The drain plug 80 can be threaded so as to be secured in a threaded drain hole 82. The drain plug 80 can thus be removed and inserted as desired so as to open and close the drain hole 82. The drain hole 82 is formed in the second portion 23 adjacent the third portion 25.

In FIG. 2, the body 12 thermally insulates the interior space 22. The lid 30 also thermally insulates the interior space 22 when in the closed position. The body 12 and lid 30 are preferably made of a high-density polymer material that insulates the interior space 22 from exterior temperatures. In FIG. 2, the body 12 of the apparatus 10 has a first portion 21, a second portion 23 angled with respect to the first portion 21, and a third portion 25 angled with respect to the second portion 23. The second portion 23 is positioned between the first portion 21 and the third portion 25. The angle θ1 between the first portion 21 and the second portion 23 is obtuse, and likewise, the angle θ2 between the second portion 23 and the third portion 25 obtuse. The second portion 23 is positioned between the first portion 21 and the third portion 25 so as to give at least a portion of the interior space 22 of the body 12 of the apparatus 10 a trapezoidal profile (the portion being defined by the part of the interior space 22 below line A-A). In the disclosed apparatus 10, angle θ1 is equal to angle θ2; however, the disclosed invention contemplates other configurations where the angles θ1 and θ2 are not equal, while both angles θ1 and θ2 are still obtuse.

The angle θ2 between the second portion 23 and the third portion 25 causes liquid H₂O to flow from the third portion 25 to the second portion 23, where the liquid H₂O can flow through drain hole 82 when drain plug 80 is removed. Likewise, the angle θ1 between the second portion 23 and the first portion 21 causes liquid H₂O to flow from the first portion 21 to the second portion 23, where the liquid H₂O can flow through drain hole 82 when drain plug 80 is removed.

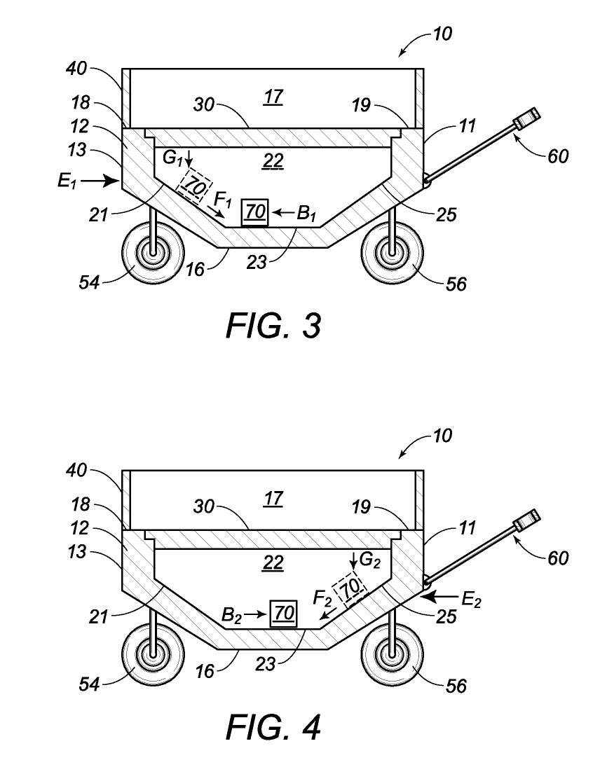

Referring to FIG. 3, there is shown a cross-sectional view of the apparatus 10, with a horizontal external force E₁ exerted on the back 13 of the apparatus 10. Force E₁ simulates a scenario where the apparatus 10 rolls backward and suddenly hits a bump or stops so that item 70 experiences force B₁ in the opposite direction of force E₁. In the apparatus 10 of the disclosed invention, the item 70 slides along the second portion 23 toward the first portion 21. When force B₁ is large enough, item 70 slides from the second portion 23 to the first portion 21. When sliding along the first portion 21 (the new position of item 70 is shown with dashed lines), force B₁ on item 70 is dampened by the downward force of gravity G₁ and the resistance force of friction F₁. Thus, the movement of item 70 within interior space 22 of the apparatus 10 is reduced by the forces of gravity and friction due to the angled configuration of the second portion 23 with respect to the first portion 21. The angle θ1 between the first portion 21 and the second portion 23 is preferably greater than ninety degrees and less than one hundred-eighty degrees so that both the force of gravity G₁ and the force of friction F₁ dampen force B₁ created by external force E₁. When movement of the item 70 is reduced, the item 70 is more stable in interior space 22 and experiences less turbulence while in the interior space 22 of the apparatus 10.

Referring to FIG. 4, there is shown a cross-sectional view of the disclosed apparatus 10, with a horizontal external force E₂ exerted on the front 11 of the apparatus 10. Force E₂ simulates a scenario where the apparatus 10 rolls forward and suddenly hits a bump or stops so that item 70 experiences force B₂ in the opposite direction of force E₂. In the apparatus 10 of the disclosed invention, the item 70 slides along the second portion 23 toward the third portion 25. When force B₂ is large enough, item 70 slides from the second portion 23 to the third portion 25. When sliding along the third portion 25 (the new position of item 70 is shown with dashed lines), force B₂ on item 70 is dampened by the downward force of gravity G₂ and the resistance force of friction F₂. Thus, the movement of item 70 within interior space 22 of the apparatus 10 is reduced by the forces of gravity and friction due to the angled configuration of the second portion 23 with respect to the third portion 25. The angle θ2 between the third portion 25 and the second portion 23 is preferably greater than ninety degrees and less than one hundred-eighty degrees so that both the force of gravity G₂ and the force of friction F₂ dampen force B₂ created by external force E₂. When movement of the item 70 is reduced, the item 70 is more stable in interior space 22 and experiences less turbulence while in the interior space 22 of the apparatus 10.

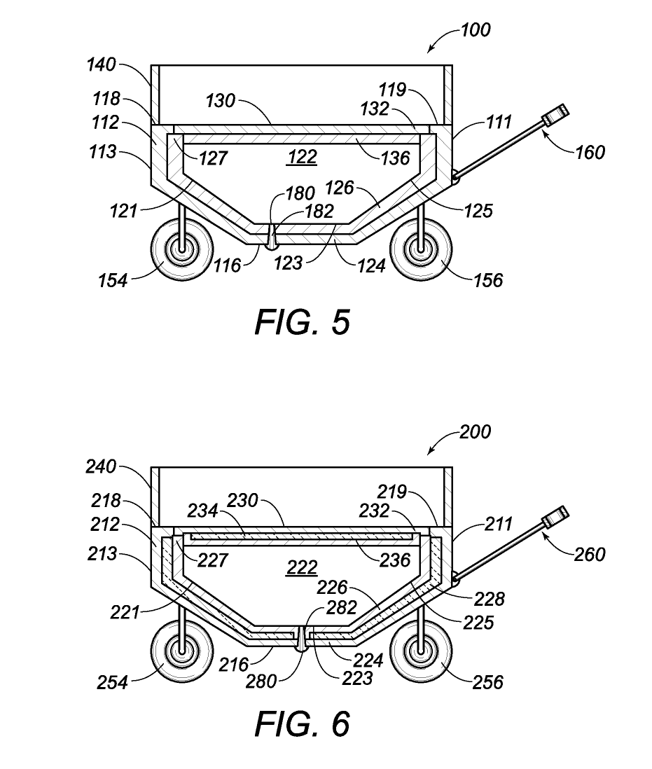

Referring to FIG. 5, there is shown a cross-sectional view of an alternative embodiment of the apparatus 100, where the body 112 has two layers—an outer layer 124 an inner layer 126. Like FIGS. 2 through 4, the cross-sectional view of FIG. 5 is taken along sight-line 2-2 of FIG. 1. It can be seen that the apparatus 100 is substantially configured like apparatus 10 shown in FIGS. 2 through 4: the apparatus 100 has a body 112, wheels 154 attached to the bottom 116 of the body 112 where two 156 of the wheels 154 are rotatable with respect to the body 112, walls 140 extending upwardly from the periphery 118 of the body 112, a lip 119 extending inwardly from the periphery 118 further than the walls 140, a handle 160 pivotally connected to the front 111 of the body 112, and a lid 130 that has an open position and a closed position.

In FIG. 5, the body 112 has first portion 121, second portion 123, and third portion 125. Each of the portions 121, 123, and 125 of the body 112 has an inner layer 126 and an outer layer 124. The inner layer 126 of the body 112 is positioned between the interior space 122 and the outer layer 124 of the body 112. The drain hole 182 is formed through both the outer layer 124 and the inner layer 126 of the bottom 116 of the body 112, in the second portion 123. When both layers 124 and 126 are impermeable to H₂O, the drain hole 182 can be formed directly through the layers 124 and 126 without concern that H₂O will flow into the layers 124 and 126 or get trapped between the layers 124 and 126. The drain plug 180 is made of a material impermeable to H₂O, and preferably of a lightweight plastic. The drain plug 180 can be made of an elastic material, and when so made, the drain plug 180 is formed to have a slightly larger diameter than a diameter of the drain hole 182 so that the drain plug 180 is compressed in the drain hole 182 to form a seal impenetrable by H₂O.

The inner layer 126 of the body 112 is preferably made of an insulating polymeric material, and the outer layer 124 is preferably made of a polymeric material. The polymeric material of the outer layer 124 is rigid, and the insulating polymeric material of the inner layer 126 is impermeable to H₂O. The polymeric material of the outer layer 124 also preferably impermeable to H₂O. The insulating polymeric material of the inner layer 126 both insulates items in the interior space 122 of the apparatus 100 and dampens the movement of items in the interior space 122 of the apparatus 100. The material of the inner layer 126 has at least some degree of elasticity (is elastic) so as to dampen the movement of items in the interior space 122 when the apparatus 100 travels or when the apparatus 100 abruptly changes velocity. Items are dampened when contacting the inner layer 126 because the inner layer 126 compresses slightly due to the force of the movement of the items. The compression of the inner layer 126 thus counteracts the momentum of the items and dampens the movement of the items. Preferably, the material of the inner layer 126 is a low-density polymer that is impermeable to H₂O, is elastic, and insulates items in the interior space 122. Preferably, the material of the outer layer 124 is a high-density polymer that is impermeable to H₂O and rigid. The outer layer 124 thus has a density greater than a density of the inner layer 126.

The lid 130 of the apparatus 100 in FIG. 5 also has two layers: upper layer 132 and lower layer 136. The upper layer 132 is made of a polymeric material. Preferably, the material of the upper layer 132 is a high-density polymer that is rigid and impermeable to H₂O. The lower layer 136 is made of an insulting polymeric material. The insulating polymeric material of the lower layer 136 both insulates items in the interior space 122 of the apparatus 100 and dampens the movement of items in the interior space 122 of the apparatus 100. The material of the lower layer 136 has at least a degree of elasticity (is elastic) so as to dampen the movement of items in the interior space 122 when the apparatus 100 travels or when the apparatus 100 abruptly changes velocity. Preferably, the material of the lower layer 136 is a low-density polymer, is elastic, and insulates items in the interior space 122 of the apparatus 100 from temperatures exterior of the apparatus 100. The upper layer 132 of the lid 130 extends toward the periphery 118 of the body 112 further than the lower layer 130 of the lid 130, and the upper layer 132 meets with the lip 119 formed with the outer layer 124 of the body 112.

The end 127 of the inner layer 126 of the body 112 is adjacent the lower layer 136 and the upper layer 132 of the lid 130 when the lid 130 is in the closed position. This configuration ensures items in the interior space 122 are completely enclosed in the insulating polymeric material of the lower layer 136 of the lid 130 and the inner layer 126 of the body 112. The end 127 is also adjacent the outer layer 124 and the lip 119. The lip 119 is formed integrally with the outer layer 124 and extends inwardly from the periphery 118 of the body 112 over the end 127 of the inner layer 126. This configuration ensures the softer material of the inner layer 126 and the lower layer 136 is protected by the harder, rigid material of the outer layer 124 and the upper layer 132. The materials of the inner layer 126 and the lower layer 136 are preferably the same material. The materials of the outer layer 124 and the upper layer 132 are preferably the same material. The portions 121, 123, and 125 of the body 112 are angled to form a trapezoidal profile for a portion of the interior space 122. Alternatively, the lower layer 136 of the lid 130 and the inner layer 126 of the body 112 can form a trapezoidal profile when the lid 130 is in the closed position so that the entire interior space 122 has a trapezoidal profile.

Referring to FIG. 6, there is shown a cross-sectional view of another embodiment of the apparatus 200, where the body 212 has three layers—an outer layer 224, an inner layer 226, and a middle layer 228 positioned between the inner layer 226 and outer layer 224. Like, FIGS. 2 through 4, the cross-sectional view of FIG. 6 is taken along sight-line 2-2 of FIG. 1. It can be seen that the apparatus 200 is substantially configured like apparatus 10 shown in FIGS. 2 through 4: the apparatus 200 has a body 212, wheels 254 attached to the bottom 216 of the body 212 where two 256 of the wheels 254 are rotatable with respect to the body 212, walls 240 extending upwardly from the periphery 218 of the body 212, a lip 219 extending inwardly from the periphery 218 further than the walls 240, a handle 260 pivotally connected to the front 211 of the body 212, and a lid 230 that has an open position and a closed position.

In FIG. 6, the body 212 has first portion 221, second portion 223, and third portion 225. Each of the portions 221, 223, and 225 of the body 212 has an inner layer 226, a middle layer 228, and an outer layer 224. The inner layer 226 of the body 212 is positioned between the interior space 222 and the outer layer 224 of the body 212. The middle layer 228 is positioned between the inner layer 226 and the outer layer 224. The drain hole 282 is formed through both the outer layer 224 and the inner layer 226 of the bottom 216 of the body 212. When both layers 224 and 226 are impermeable to H₂O, the drain hole 282 can be formed directly through the layers 224 and 226 without concern that H₂O will flow into the layers 224 and 226 or get trapped between the layers 224 and 226. The drain plug 280 is made of a material impermeable to H₂O, and preferably of a lightweight plastic. The drain plug 280 can be made of an elastic material, and when so made, the drain plug 280 is formed to have a slightly larger diameter than a diameter of the drain hole 282 so that the drain plug 280 is compressed in the drain hole 282 to form a seal impermeable to H₂O.

The middle layer 228 is preferably made of an insulating material, such as fiberglass. Insulating materials can be permeable to H₂O, so outer layer 224 and inner layer 226 must be formed of materials impermeable to H₂O. The inner layer 226 is made of a polymeric material, and the outer layer 224 is made of a polymeric material. The polymeric material of the inner layer 226 dampens the movement of items in the interior space 222 of the apparatus 200. Further, the polymeric material of the inner layer 226 is preferably elastic so as to dampen the movement of items in the interior space 222 when the apparatus 200 travels or when the apparatus 200 abruptly changes velocity. Items are dampened when contacting the inner layer 226 because the inner layer 226 compresses slightly due to the force of the movement of the items. The compression of the inner layer 226 thus counteracts the momentum of the item and dampens the movement of the item.

The polymer material of the inner layer 226 can have a density equal to a density of the polymer material of the outer layer 224, or the polymer material of the inner layer 226 can have a density less than a density of the polymer material of the outer layer 224. When the density of the inner layer 226 is less than the density of the outer layer 224, the inner layer 226 is preferably a low-density polymer that is elastic. Because of the nature of low-density polymers, the inner layer 226 of apparatus 200 may have insulating properties that complement the insulating properties of the insulating material of the middle layer 228; however, the insulating material of the middle layer 228 has a greater degree of insulation than the inner layer 226. In either scenario, the polymer material of the outer layer 224 is high-density polymer and is rigid. In the context of apparatus 200, which has three layers 224, 226, and 228 in the body 212, when the density of the inner layer 226 equals the density of the outer layer 224, the polymer material of the inner layer 226 is high density polymer and is rigid.

The lid 230 of apparatus 200 in FIG. 6 also has three layers: an upper layer 232, a lower layer 236, and an intermediate layer 234 positioned between the upper layer 232 and lower layer 236. The upper layer 232 is made of a polymeric material. Preferably, the material of the upper layer 232 is a high-density polymer that is rigid and impermeable to H₂O. The lower layer 236 is made of a polymeric material as well. The polymeric material of the lower layer 236 is elastic and dampens the movement of items in the interior space 222 of the apparatus 200 when the apparatus 200 travels or when the apparatus 200 abruptly changes velocity. The upper layer 232 of the lid 230 extends toward the periphery 218 of the body 212 further than the lower layer 236 and intermediate layer 234 of the lid 230. The lower layer 236 extends toward the periphery 218 of the body 212 further than the intermediate layer 234 of the lid 230. The upper layer 232 meets with the lip 219 formed with the outer layer 224 of the body 212.

The end 227 of the inner layer 226 of the body 212 is adjacent the lower layer 236 and the upper layer 232 of the lid 230 when the lid 230 is in the closed position. This configuration ensures items in the interior space 222 are completely enclosed in the polymeric material of the lower layer 226 of the lid 230 and the inner layer 226 of the body 212. The insulating material of the intermediate layer 234 and the middle layer 228 extend substantially around the interior space 222. The end 227 of the inner layer 226 is also adjacent the lip 219. The lip 219 is formed integrally with the outer layer 224 and extends inwardly from the periphery 218 of the body 212 to the end 227 of the inner layer 226 and over the middle layer 228 of the body 212. This configuration ensures the softer material of the intermediate layer 234 and middle layer 228, and the material of the inner layer 226 and the lower layer 236 are protected by the harder, rigid material of the outer layer 224 and the upper layer 232. The intermediate layer 234 of the lid 230 is completely enclosed by the lower layer 236 and the upper layer 232. The middle layer 228 of the body 212 is completely enclosed by the inner layer 226 and the outer layer 224. The materials of the inner layer 226 and the lower layer 236 are preferably the same material. The materials of the outer layer 224 and the upper layer 232 are preferably the same material. The materials of the intermediate layer 234 and the middle layer 228 are preferably the same material. The portions 221, 223, and 225 of the body 212 are angled to form a trapezoidal profile for a portion of the interior space 222. Alternatively, the lower layer 236 of the lid 230 and the inner layer 226 of the body 212 can form a trapezoidal profile when the lid 230 is in the closed position so that the entire interior space 222 has a trapezoidal profile.

Because the insulating material of the middle layer 228 is permeable to H₂O, the middle layer 228 does not extend into the drain hole 282. In FIG. 6, the drain hole 282 is formed in the bottom 216 of the body 212, in the second portion 223 of the body 212. The inner layer 226 in the second portion 223 of the body 212 extends downwardly along the drain hole 282 so that H₂O does not absorb into the middle layer 228. The inner layer 226 extends along the drain hole 282 and connects to the outer layer 224. The drain hole 282 thus is formed only through the inner layer 226 and the outer layer 224, which are impermeable to H₂O, and the drain hole 282 is not formed through the material of the middle layer 228. The portion of the inner layer 226 that extends along the wall of the drain hole 282 isolates the insulating material of the middle layer 228 from any H₂O in the interior space 222 of the apparatus 200.

In FIG. 6, the inner layer 226 and lower layer 236 provide dampening of movement for items in the interior space 222 of the apparatus 200, the middle layer 228 and the intermediate layer 234 provide insulation for items in the interior space 222, and the outer layer 224 and the upper layer 232 provide rigidity and support for the other layers 226, 228, 234, and 236, and for items in the interior space 222 of the apparatus 200.

Forming the disclosed apparatus 10, 100, and 200 of polymeric materials created high-strength and corrosion-proof insulated utility wagons. The polymeric materials can be high-density polymer, which provides rigidity as the apparatus 10, 100, 200 are bumped and moved from location to location.

Because the body 12, 112, and 212 of the disclosed apparatus 10, 100, and 200 insulates items placed in the interior space 22, 122, 222, and because the walls 40, 140, and 240 carry and hold items not in need of insulation, apparatus 10, 100, and 200 allows for transport of both beverages that need insulation to stay cold or warm and other items which do not need insulation, and in doing so, simplifies recreational experiences such as picnicking and going to the beach.

The foregoing description is illustrative and explanatory of the disclosed embodiments. Various changes can be made to the embodiments and elements of one embodiment can be combined with elements of another embodiment without departing from the spirit and scope of the invention. Therefore, the invention should be limited only by the following claims and their legal equivalents.

I claim:

1. An apparatus comprising:
a body having an interior space, the body for thermally insulating the interior space, the body for dampening a movement of items in the interior space;
at least one lid hingedly attached adjacent the top of the body, the lid having an open position and a closed position, the lid for thermally insulating the interior space when in the closed position;
a plurality of walls extending upwardly from the top of the body, each of the plurality of walls being adjacent a periphery of the body, the plurality of walls defining an enclosed space above the body, the lid being accessible through the enclosed space;
a plurality of wheels attached to a bottom of the body, at least two of the plurality of wheels being rotatable with respect to the body; and
a handle pivotally attached to a front of the body.

2. The apparatus of claim 1, the lid being planar with a top of the body when in the closed position, the lid being in interference-fit relationship with the top of the body when the lid is in the closed position.

3. The apparatus of claim 1, the body comprising:
a first portion;
a second portion angled with respect to the first portion; and
a third portion angled with respect to the second portion, the second portion being positioned between the first portion and the third portion, the angle between the first portion and the second portion being obtuse, the angle between the second portion and the third portion being obtuse.

4. The apparatus of claim 3, at least a portion of the interior space of the body having a trapezoidal profile.

5. The apparatus of claim 1, the lid comprising:
an upper layer; and
a lower layer positioned between the upper layer and the interior space of the body when the lid is in the closed position, the upper layer comprising a high-density polymeric material.

6. The apparatus of claim 5, the lower layer comprising a low-density polymeric material.

7. The apparatus of claim 5, the upper layer being rigid, the lower layer being elastic.

8. The apparatus of claim 5, the lid further comprising:
an intermediate layer positioned between the upper layer and the lower layer, the intermediate layer comprising an insulating material.

9. The apparatus of claim 1, the body comprising:
an outer layer;
an inner layer positioned between the outer layer and the interior space of the body, the outer layer comprising a high-density polymeric material, the outer layer and the inner layer being impermeable to H₂O.

10. The apparatus of claim 9, the inner layer comprising a low-density polymeric material,

11. The apparatus of claim 9, the body further comprising:
a middle layer positioned between the inner layer and outer layer, the middle layer comprising an insulating material.

12. The apparatus of claim 9, the polymeric material of the inner layer having a density less than a density of the polymeric material of the outer layer.

13. The apparatus of claim 12, the outer layer being rigid, the inner layer being elastic.

14. The apparatus of claim 10, the lid comprising:
an upper layer; and
a lower layer positioned between the upper layer and the interior space of the body when the lid is in the closed position, the lower layer comprising a low-density polymeric material, the lower layer of the lid contacting the inner layer of the body when the lid is in the closed position.

15. The apparatus of claim 14, the lower layer of the lid being elastic, the inner layer of the body being elastic.

16. The apparatus of claim 14, the lower layer of the lid and the inner layer of the body forming a trapezoidal profile when the lid is in the closed position.

17. The apparatus of claim 1, the plurality of walls comprising:
a first wall having a side and an opposite side;
a second wall having a side in contact with the opposite side of the first wall;
a third wall having a side in contact with an opposite side of the second wall; and
a fourth wall having a side in contact with an opposite side of the third wall, the fourth wall having an opposite side in contact with the side of the first wall.

18. The apparatus of claim 17, each of the plurality of walls comprising a high-density polymeric material, the plurality of walls being integrally formed with the body.

19. The apparatus of claim 1, the top of the body having a lip, the lip extending inwardly from the periphery further than the plurality of walls, the lip comprising a high-density polymeric material.

20. The apparatus of claim 19, the body having an inner layer positioned between the interior space and an outer layer, the inner layer having an end adjacent the lip and adjacent the outer layer.
